(19) United States
(12) Patent Application Publication
(10) Pub. No.: US 2003/0179817 A1
(43) Pub. Date: Sep. 25, 2003

(54) Method of transmitting signals for a magnetic levitation train

(76) Inventors: Alfred Plattner, Dornstadt (DE); Manfred Mueller, Senden (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/324,108

(22) Filed: Dec. 20, 2002

(30) Foreign Application Priority Data
Dec. 21, 2001 (DE) 101 63 614.8

(51) Int. Cl. H04B 1/38; H04L 5/16

(52) U.S. Cl. 375/219

(57) ABSTRACT

In a method of transmitting electromagnetic signals between a stationary transmitting/receiving station and a transmitting/receiving station in a magnetic levitation train vehicle, the magnetic levitation train vehicle is guided on a travel path that includes stator laminations arranged on its underside. Signals to be transmitted are coupled from a travel-path-side coupling-in point connected with the stationary transmitting/receiving station into the stator laminations of at least one travel path side of the magnetic levitation train, and are decoupled from a vehicle-side coupling-out point connected with the transmitting/receiving station in the vehicle out of the stator laminations and vice-versa. The stator laminations are used as a transport medium of signals between the respective coupling-in and coupling-out point.

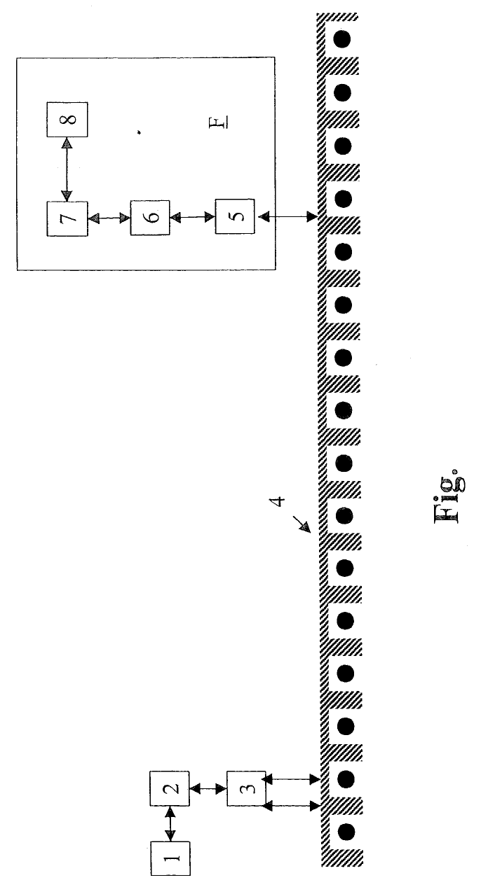

### BACKGROUND AND SUMMARY OF THE INVENTION

This application claims the priority of German patent application 101 63 614.8, filed Dec. 21, 2001, the disclosure of which is expressly incorporated by reference herein.

The invention relates to a method of transmitting electromagnetic signals between a stationary transmitting/receiving station and a transmitting/receiving station situated in a vehicle which is part of a magnetic levitation train.

Transmission of signals by radio between a stationary transmitting/receiving station and a vehicle of a magnetic levitation train is known. For this purpose, a radio system consists of a centralized main radio station, several decentralized radio stations, base stations with antenna masts and the mobile stations in the vehicles of the magnetic levitation train. Such a radio system is used both for operations management and for voice and data communication between the centralized main radio station and the vehicles.

For example, Magazine article from the journal Systeme, 9/99 Edition, http://www.ikon-gmbh.de/german/news/Artikel% 20Systeme@20Transrapid.html describes a system which permits communication with commercially available Euro ISDN equipment. In the known system, the centralized main radio station controls the entire radio network. However, it is problematic that, for implementing a large-surface radio network, the centralized main radio station has to be connected with several base stations having antenna masts. This results in considerable and cost-intensive expenditures. It is another problem that such radio networks are very susceptible to interference.

It is therefore an object of the invention to provide a transmission method of the generic type which is less susceptible to interferences.

Another object of the invention is to provide such a method which permits signal transmission between a stationary centralized main station and the vehicle of a magnetic levitation train without the high constructional expenditures of a large-surface radio network.

These and other objects and advantages are achieved by the transmission method according to the invention, in which the signals to be transmitted are coupled from one or more travel-path-side coupling-in points connected with the stationary transmitting/receiving station into the stator laminations of at least one side of the travel path of the magnetic levitation train, and are decoupled out of the stator laminations via one or more vehicle-side coupling-out points connected with the transmitting/receiving station in the vehicle, and vice-versa. The stator laminations are used as a transport medium of the signals between the respective coupling-in and coupling-out point.

The principle of the magnetic levitation train is well known, and is based essentially on the attractive powers between individually controlled electromagnets mounted in the vehicle and the ferromagnetic reaction rails, also called stator laminations, mounted on the underside of the travel path. A synchronous long-stator linear motor is used both as a drive and as a brake in the travel path. The method of operation can be derived from the operating method of a rotating electric motor whose stator is cut open and stretched. A more detailed description can be obtained, for example, from Physikalische Blätter 57 (2001) No. 6, Pages 80-81.

One advantage of the invention is the fact that no high constructional expenditures are required for implementing signal transmission according to the invention. Furthermore, the signal transmission according to the invention is not susceptible to interference because it is not based on radio transmission. The transmission of signals takes place by means of signal packets which in this case represent a type of waveguide for the signals.

Another important advantage of the invention is the fact that already existing system parts can be utilized. Furthermore, by means of the method according to the invention, a bidirectional signal transmission can be established between the magnetic levitation vehicle and the stationary system parts (such as the stationary transmitting/receiving station), in which, in addition to voice, data can also be transmitted.

Advantageously, several coupling-in and coupling-out points are provided on the travel path side and the vehicle side, so that redundancy is increased. The coupling-in and coupling-out points can be capacitively coupled with the stator laminations. However, in another embodiment, it is possible for the coupling-in and coupling-out points to be inductively coupled with the stator laminations.

In another embodiment of the invention, the same signals can be transported respectively in the stator laminations of the two travel path sides. Here, it is an advantage that one of the two travel path sides is in each case available as a redundant signal path. Thus, when one travel path side fails as a signal path, a loss of data will be avoided.

In another embodiment of the invention, different signals can be transported in the stator laminations of the two travel path sides. An advantage of this arrangement is that the capacity of the data transmission can be increased significantly.

It is also advantageous that a modem is provided on each of the vehicle side and the travel path side, and modulates the signals to be transmitted to a suitable carrier frequency. The carrier frequency may depend on the transmission characteristics of the stator laminations and, in particular, is a function of the windings of which the stator laminations are constructed.

The signals to be transmitted may be amplitude-modulated or phase-modulated by the modems. However, it is also possible that the signals are pulse-modulated. During the pulse modulation, the pulse amplitude, the pulse duration, the pulse phase, the pulse frequency or a combination thereof can be modulated.

In another embodiment of the invention, the signal transmission can take place in a half-duplex manner so that the transmitting and receiving of the signals takes place at different times on the same frequency. However, it is also conceivable that the signal transmission takes place in a full-duplex manner so that the transmitting and transmitting of the signals takes place at the same times on different frequencies.

In another embodiment of the invention, to increase the signal transmission range of the stator laminations, repeaters are present at definable distances for processing the signals. These repeaters serve to compensate signal breakups that -occur because of radiation losses of the stator laminations. The signals to be originally transmitted are recovered in the repeater by measures known to a person skilled in the art, are processed and are subsequently again fed into the stator laminations. Furthermore, a repeater is used as a type of signal amplifier. A repeater can therefore be used as a coupling-in and coupling-out point for the signal to be transmitted. The signals to be transmitted may be fed to the repeaters by means of lightwave cables.

Energy required for the operation of the repeaters may be obtained stator laminations by inductive coupling.

Other objects, advantages and novel features of the present invention will become apparent from the following detailed description of the invention when considered in conjunction with the accompanying drawings.

### BRIEF DESCRIPTION OF THE DRAWINGS

The single figure of the drawing shows an arrangement for implementing the method according to the invention.

### DETAILED DESCRIPTION OF THE DRAWINGS

For the transmission of electromagnetic signals from a stationary transmitter 1 to a receiver 8 in a magnetic levitation train F, the signals to be transmitted (such as data or voice signals) are guided from the stationary transmitter/receiver 1 to a modem 2, where they are modulated, by means of a suitable modulation process, to a carrier frequency which is adapted to the transmission characteristics of the stator laminations 4. In the modulation process, additional band-spreading modulations, such as the direct sequence spread spectrum (DSSS) or short-pulse modulations, can be used. The modulated signals are fed by means of an adaptation circuit 3 into the stator laminations 4. In this case, the feeding, in particular, takes place directly onto the windings (not shown) of the stator laminations 4, which guide the signals to the vehicle F. The stator laminations 4 are thus used as waveguides for transmission of the modulated electromagnetic signals, in addition to their actual task of generating the travelling wave for the drive of the vehicle F.

On the vehicle F, antennas 5 are arranged whose distance from the stator laminations amounts to several centimeters, particularly less than 15 centimeters. The modulated signals transported in the stator laminations 4 are coupled out by means of the antennas 5. The coupled-out signals are amplified in a transmitting/receiving amplifier 6 and are fed to a modem 7 for the purpose of demodulation and are subsequently guided to the receiver 8.

The transmission of electromagnetic signals from a transmitter 8 in a magnetic levitation vehicle F to a stationary receiver 1 takes place in a corresponding manner. In this case, the signals of the transmitter 8 are modulated in a modem 7 and, by means of the transmitting/receiving amplifier 6 and the antenna 5, are coupled into the stator laminations 4. By means of the adaptation circuit 3, the signals transported in the stator laminations 4 are coupled out. The signals are demodulated in the modem and are fed to the stationary receiver 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of transmitting electromagnetic signals between a stationary transmitting/receiving station and a transmitting/receiving station in a magnetic levitation train guided on a travel path that has two sides and includes stator laminations arranged on the underside of the travel path; said method comprising:
coupling transmission signals from at least one stationary coupling-in point connected with the stationary transmitting/receiving station, into the stator laminations of at least one side of the travel path;
decoupling said signals from the stator laminations, into a coupling-out point situated on the train and connected with the transmitting/receiving station in the train; and
transmitting signals from the transmitting/receiving station in the train to the stationary transmitting/receiving station in a corresponding manner;
wherein the stator laminations are used as a transport medium for the signals between the respective coupling-in and coupling-out points.

2. The method according to claim 1, comprising a plurality of stationary coupling-in and coupling-out points on the travel path side and a plurality of coupling-in and coupling-out points on the train.

3. The method according to claim 2, wherein identical transmission signals are coupled to the stator laminations of both travel path sides.

4. The method according to claim 2, wherein differing transmission signals are coupled to the stator laminations of the two travel path sides.

5. The method according to claim 1, wherein on the vehicle side and on the travel path side, the transmission signals are modulated via a modem, to a carrier frequency corresponding to transmission characteristics of the stator laminations.

6. The method according to claim 5, wherein the transmission signals are amplitude-modulated.

7. The method according to claim 5, wherein the transmission signals are phase-modulated.

8. The method according to claim 5, wherein:
the transmission signals are pulse-modulated; and
the pulse amplitude, pulse duration, pulse phase, pulse frequency or a combination thereof are modulated.

9. The method according to claim 1, wherein the coupling-in and coupling-out points are inductively coupled with the stator laminations.

10. The method according to claim 1, wherein the coupling-in and coupling-out points are capacitively coupled with the stator laminations.

11. The method according to claim 1, wherein transmission of the signals takes place in a half-duplex manner, whereby transmitting and reception of signals is permitted at different times on the same frequency.

12. The method according to claim 1, wherein transmission of the signals takes place in a full-duplex manner, whereby transmitting and reception of signals is permitted at the same times on different frequencies.

13. The method according to claim 1, further comprising repeaters for the processing of signals, said repeaters being situated at definable distances along the travel path.

14. The method according to claim 13, wherein energy required for the operation of the repeaters is obtained from the stator laminations by inductive coupling.

15. The method according to claim 13, wherein the signals to be transmitted are supplied to the repeaters by means of optical cables.
